(19) United States
(12) Patent Application Publication
(10) Pub. No.: US 2022/0041019 A1
(43) Pub. Date: Feb. 10, 2022

(54) Module Hooping Reinforcement for a Tire of a Heavy Duty Civil Engineering Vehicle

(71) Applicant: COMPAGNIE GENERALE DES ETABLISSEMENTS MICHELIN, Clermont-Ferrand (FR)

(72) Inventors: Cédric KHAYAT, Clermont-Ferrand Cedex 9 (FR); Vincent ESTENNE, Clermont-Ferrand Cedex 9 (FR)

(21) Appl. No.: 17/275,642

(22) PCT Filed: Sep. 5, 2019
(86) PCT No.: PCT/EP2019/073732

§ 371 Date: Mar. 11, 2021

(30) Foreign Application Priority Data
Sep. 12, 2018 (FR) 1858171

(51) Int. Cl. B60C 9/20; B60C 9/00

(52) U.S. Cl. CPC B60C 9/2006; B60C 9/0007; B60C 2009/2029; B60C 2200/06; B60C 2009/2077; B60C 2009/208; B60C 2009/2016

(57) ABSTRACT

A radial tire (1) for a heavy-duty vehicle of construction plant type, and aims to increase the rupture strength of the hoop reinforcement thereof having circumferential layers, ensuring satisfactory endurance of the crown reinforcement thereof. According to the invention, the at least one circumferential hooping layer (71, 72) comprises a median portion (711, 721) having a median width (L11, L21) and a median tensile elastic modulus (E11, E21), and two lateral portions (712, 722) that axially extend the median portion (711, 721) on either side and each have a lateral width (L12, L22) and a lateral tensile elastic modulus (E12, E22), the lateral width (L12, L22) is at least equal to 0.05 times the median width (L11, L21), and the lateral tensile elastic modulus (E12, E22) is at most equal to 0.9 times the median tensile elastic modulus (E11, E21).

The subject of the present invention is a radial tire intended to be fitted to a heavy-duty vehicle of construction plant type, and the invention relates more particularly to the crown reinforcement of such a tire, and even more particularly to the hoop reinforcement thereof.

Typically, a radial tire for a heavy-duty vehicle of construction plant type, within the meaning of the European Tire and Rim Technical Organization or ETRTO standard, is intended to be mounted on a rim with a diameter at least equal to 25 inches. Although not limited to this type of application, the invention is described for a radial tire of large size, which is intended to be mounted on a dumper, a vehicle for transporting materials extracted from quarries or surface mines, by way of a rim with a diameter at least equal to 49 inches, possibly as much as 57 inches, or even 63 inches.

Since a tire has a geometry exhibiting symmetry of revolution about an axis of rotation, the geometry of the tire is generally described in a meridian plane containing the axis of rotation of the tire. For a given meridian plane, the radial, axial and circumferential directions denote the directions perpendicular to the axis of rotation of the tire, parallel to the axis of rotation of the tire and perpendicular to the meridian plane, respectively. The circumferential direction is tangential to the circumference of the tire.

In the following text, the expressions “radially inner/radially on the inside” and “radially outer/radially on the outside” mean “closer to” and “further away from the axis of rotation of the tire”, respectively. “Axially inner/axially on the inside” and “axially outer/axially on the outside” mean “closer to” and “further away from the equatorial plane of the tire”, respectively, with the equatorial plane of the tire being the plane that passes through the middle of the tread surface and is perpendicular to the axis of rotation.

Generally, a tire comprises a tread intended to come into contact with the ground via a tread surface, the two axial ends of which are connected via two sidewalls to two beads that provide the mechanical connection between the tire and the rim on which it is intended to be mounted.

A radial tire also comprises a reinforcement made up of a crown reinforcement radially on the inside of the tread and of a carcass reinforcement radially on the inside of the crown reinforcement.

The carcass reinforcement of a radial tire for a heavy-duty vehicle of construction plant type usually comprises at least one carcass layer comprising generally metal reinforcers that are coated in a polymeric material of the elastomer or elastomeric type that is obtained by blending and is known as a coating compound. A carcass layer comprises a main part that joins the two beads together and is generally wound, in each bead, from the inside of the tire to the outside around a usually metal circumferential reinforcing element known as a bead wire so as to form a turn-up. The metal reinforcers of a carcass layer are substantially mutually parallel and form an angle of between 85° and 95° with the circumferential direction.

The crown reinforcement of a radial tire for a heavy-duty vehicle of construction plant type comprises a superposition of circumferentially extending crown layers, radially on the outside of the carcass reinforcement. Each crown layer is made up of generally metal reinforcers that are mutually parallel and are coated in a polymeric material of the elastomer or coating compound type.

As regards the metal reinforcers, a metal reinforcer is mechanically characterized by a curve representing the tensile force (in N) applied to the metal reinforcer as a function of the relative elongation (in %) thereof, known as the force-elongation curve. Mechanical tensile characteristics of the metal reinforcer, such as the structural elongation As (in %), the total elongation at break At (in %), the force at break Fm (maximum load in N) and the breaking strength Rm (in MPa) are derived from this force-elongation curve, these characteristics being measured in accordance with the standard ISO 6892 of 1984.

The total elongation at break At of the metal reinforcer is, by definition, the sum of the respectively structural, elastic and plastic elongations thereof (At=As+Ae+Ap). The structural elongation As results from the relative positioning of the metal threads making up the metal reinforcer under a low tensile force. The elastic elongation Ae results from the intrinsic elasticity of the metal of the metal threads making up the metal reinforcer, taken individually, the behaviour of the metal following Hooke's law. The plastic elongation Ap results from the plasticity, that is to say the irreversible deformation beyond the yield point, of the metal of these metal threads taken individually. These various elongations and the respective meanings thereof, which are well known to a person skilled in the art, are described, for example, in the documents U.S. Pat. No. 5,843,583, WO2005/014925 and WO2007/090603.

Also defined, at any point on the force-elongation curve of a metal reinforcer, is a tensile modulus, expressed in GPa, which represents the gradient of the straight line tangential to the force-elongation curve at this point. In particular, the tensile modulus of the elastic linear part of the force-elongation curve is referred to as the tensile elastic modulus or Young's modulus.

Among the metal reinforcers, a distinction is usually made between the elastic metal reinforcers and the inextensible or non-extensible metal reinforcers. An elastic metal reinforcer is characterized by a structural elongation As at least equal to 1% and a total elongation at break At at least equal to 4%. Moreover, an elastic metal reinforcer has a tensile elastic modulus at most equal to 150 GPa, and usually between 40 GPa and 150 GPa. An inextensible metal reinforcer is characterized by a total elongation At, under a tensile force equal to 10% of the force at break Fm, at most equal to 0.2%. Moreover, an inextensible metal reinforcer has a tensile elastic modulus usually between 150 GPa and 200 GPa.

As regards the crown layers of the crown reinforcement, a distinction is usually made between the protective layers, which make up the protective reinforcement and are radially outermost, and the working layers, which make up the working reinforcement and are radially comprised between the protective reinforcement and the carcass reinforcement.

The protective reinforcement, which comprises at least one protective layer, essentially protects the working layers from mechanical or physicochemical attacks, which are likely to spread through the tread radially towards the inside of the tire.

The protective reinforcement often comprises two protective layers, which are radially superposed, formed of elastic metal reinforcers, are mutually parallel in each layer and are crossed from one layer to the next, forming angles at least equal to 10° with the circumferential direction.

The working reinforcement, comprising at least two working layers, has the function of belting the tire and conferring stiffness and road holding thereon. It absorbs both mechanical inflation stresses, which are generated by the tire inflation pressure and transmitted by the carcass reinforcement, and mechanical stresses caused by running, which are generated as the tire runs over the ground and are transmitted by the tread. It is also intended to withstand oxidation and impacts and puncturing, by virtue of its intrinsic design and that of the protective reinforcement.

The working reinforcement usually comprises two working layers, which are radially superposed, are formed of inextensible metal reinforcers, are mutually parallel within each layer and are crossed from one layer to the next, forming angles at most equal to 60°, and preferably at least equal to 15° and at most equal to 45°, with the circumferential direction.

Moreover, in order to reduce the mechanical inflation stresses that are transmitted to the working reinforcement, it is known to dispose a hoop reinforcement, having a high circumferential tensile stiffness, radially on the outside of the carcass reinforcement. The hoop reinforcement, the function of which is to at least partially absorb the mechanical inflation stresses, also improves the endurance of the crown reinforcement by stiffening the crown reinforcement, when the tire is compressed under a radial load and, in particular, subjected to a cornering angle about the radial direction.

The hoop reinforcement usually comprises two radially superposed hooping layers formed of metal reinforcers that are mutually parallel within each layer and are crossed from one layer to the next, forming angles at most equal to 10° with the circumferential direction. The hoop reinforcement can be positioned radially on the inside of the working reinforcement, between the two working layers of the working reinforcement, or radially on the outside of the working reinforcement.

Among the hooping layers, a distinction is made between the hooping layers known as closed-angle hooping layers, that is to say in which the metal reinforcers form angles at least equal to 5° and at most equal to 10° with the circumferential direction, and the circumferential, more specifically substantially circumferential, hooping layers, that is to say in which the metal reinforcers form angles at most equal to 5°, and possibly zero, with the circumferential direction. The closed-angle hooping layers comprise metal reinforcers having free ends at the axial ends of the hooping layers. The circumferential hooping layers comprise metal reinforcers that do not have free ends at the axial ends of the hooping layers, since the circumferential hooping layers are usually obtained by circumferentially winding a ply of metal reinforcers or by circumferentially winding a continuous metal reinforcer.

The document WO 2014048897 A1 has the objective of desensitizing the crown of a radial tire for a heavy-duty vehicle of construction plant type to impacts that occur more or less at the centre of its tread, and describes an additional reinforcement centred on the equatorial plane of the tire, comprising at least one additional layer formed of metal reinforcers that make an angle at most equal to 10° with the circumferential direction, the metal reinforcers of each additional layer being elastic and having a tensile elastic modulus at most equal to 150 GPa. The additional reinforcement, described in that document, is therefore a hoop reinforcement having elastic metal reinforcers, the hooping layers being able to be either closed-angle hooping layers or circumferential hooping layers.

The document WO 2016139348 A1 has the objective of improving both the performance aspects of endurance with regard to cleavage and impact resistance of the crown of a tire for a heavy-duty vehicle of construction plant type, and describes a hoop reinforcement formed by a circumferential winding of a ply so as to form a radial stack of at least two hooping layers, comprising circumferential elastic metal reinforcers that make angles at most equal to 2.5° with the circumferential direction, the hoop reinforcement being radially positioned between the working layers, and the circumferential metal reinforcers of the hoop reinforcement having a force at break at least equal to 800 daN. The hoop reinforcement described in that document is therefore a hoop reinforcement made up of circumferential hooping layers having elastic metal reinforcers.

In the specific case of a hoop reinforcement having circumferential hooping layers, when the tire, running, is subjected to an axial load, parallel to its axis of rotation, also known as transverse load or lateral load, the axial ends of the circumferential hooping layers are subjected to significant tensions on account of edgewise bending, about a radial axis, of the crown reinforcement as a whole. In other words, the axially outermost metal reinforcers of the circumferential hooping layers are thus subjected to great elongations, which can cause them to break and, consequently, can damage the hoop reinforcement, this being able in turn to damage the crown reinforcement and cause the tire to be withdrawn from service prematurely.

In order to reduce the tensions in the metal reinforcers positioned at the axial ends of the circumferential hooping layers, it is known, for example, to reduce the angles formed, with the circumferential direction, by the metal reinforcers of the working layers, in order to increase the contribution of the working reinforcement to the hooping of the tire. It is also known to reduce the tensile elastic modulus of the metal reinforcers of the circumferential hooping layers, and therefore to increase the elongation capacity thereof. However, the two above-described solutions have the drawback of generating an increase in shear at the axial ends of the working layers, and therefore of reducing the endurance of the crown reinforcement, this going against the objective of hooping, which is, in particular, to control said shear and, consequently, to ensure satisfactory endurance of the crown reinforcement.

The inventors set themselves the objective, for a radial tire for a heavy-duty vehicle of construction plant type comprising a hoop reinforcement having circumferential hooping layers, of increasing the rupture strength of the hoop reinforcement, at the axial ends thereof, while ensuring satisfactory endurance of the crown reinforcement, while the tire is running, in particular when cornering.

This objective has been achieved, according to the invention, by a tire for a heavy-duty vehicle of construction plant type, comprising a crown reinforcement radially on the inside of a tread and radially on the outside of a carcass reinforcement,

the crown reinforcement comprising, radially from the outside to the inside, a protective reinforcement and a working reinforcement,

the protective reinforcement comprising at least one protective layer comprising elastic metal reinforcers having a tensile elastic modulus at most equal to 150 GPa, which are coated in an elastomeric material, are mutually parallel and form an angle at least equal to 10° with a circumferential direction tangential to the circumference of the tire,

the working reinforcement comprising two working layers that respectively comprise inextensible metal reinforcers having a tensile elastic modulus greater than 150 GPa and at most equal to 200 GPa, which are coated in an elastomeric material, are mutually parallel, form an angle at least equal to 15° and at most equal to 45° with the circumferential direction, and are crossed from one working layer to the next,

the crown reinforcement also comprising, radially on the inside of the protective reinforcement, a circumferential hoop reinforcement,

the circumferential hoop reinforcement comprising at least one circumferential hooping layer having an axial width and comprising metal reinforcers which are coated in an elastomeric material, are mutually parallel and form an angle at most equal to 5° with the circumferential direction,

the at least one circumferential hooping layer comprising a median portion having a median width and a median tensile elastic modulus, and two lateral portions that axially extend the median portion on either side and each have a lateral width and a lateral tensile elastic modulus,

the lateral width being at least equal to 0.05 times the median width,

and the lateral tensile elastic modulus being at most equal to 0.9 times the median tensile elastic modulus.

According to the invention, each hooping layer of the hoop reinforcement is broken down into a median portion and two lateral portions that extend the median portion on either side, the lateral portions being less wide and less stiff than the median portion. Each lateral portion has a width, known as the lateral width, at least equal to 5% of the median width of the median portion. In other words, the lateral width needs to be large enough compared with the median width. In addition, each lateral portion has a lateral tensile elastic modulus at most equal to 90% of the median tensile elastic modulus of the median portion. In other words, the lateral tensile elastic modulus needs to be small enough compared with the median tensile elastic modulus. By definition, the tensile elastic modulus Ec of a layer portion, made up of metal reinforcers that have a diameter D and a tensile elastic modulus E_{R} and are separated in pairs by a spacing P, which is the distance between the respective centres of two consecutive reinforcers, is equal to E_{R}*(Π*D)/(4*P).

During edgewise bending, about a radial axis, of the crown reinforcement, and thus of each hooping layer, the lateral portion of the hooping layer under tension, on account of its much lower tensile elastic modulus, and therefore of its much greater flexibility, has a greater elongation capacity than the adjacent median portion, thereby reducing the tension applied in this lateral portion and therefore the risk of the end metal reinforcers of this lateral portion breaking.

Preferably, the lateral width is at most equal to 0.5 times the median width. Above this upper limit, the tensile stiffness of the lateral portion, which is equal to the product of the lateral tensile elastic modulus and the thickness of the lateral portion divided by the lateral width, and is therefore inversely proportional to the lateral width, becomes too low in terms of relative value compared with the tensile stiffness of the median portion; this causes excessive elongation of the lateral portion and excessive tension in the end metal reinforcers of this lateral portion.

Preferably also, the lateral tensile elastic modulus is at least equal to 0.3 times the median tensile elastic modulus. Below this lower limit, the lateral tensile elastic modulus becomes too low in terms of relative value compared with the median tensile elastic modulus, resulting in insufficient hooping of the lateral portion and absorption of tensile loads, applied to the hooping layer, substantially by the median portion, with, as a result, an increased risk of cleavage at the axial ends of the working layers.

Advantageously, the working reinforcement having an axial width, the axial width of the at least one circumferential hooping layer is at least equal to 0.3 times and at most equal to 0.7 times the axial width of the working reinforcement. The axial width of the working reinforcement is defined as the width of the widest working layer, which is often the radially innermost working layer. Below the lower limit of the axial width of the working reinforcement, the hooping width is insufficient and the risk of cleavage at the axial ends of the working layers is increased. Above the upper limit, the hooping width is too great and the tensile loads in the hooping layer become excessive.

Preferably, the median portion and the lateral portions of the at least one circumferential hooping layer respectively comprise elastic metal reinforcers having a tensile elastic modulus at most equal to 150 GPa. The metal reinforcers of the median portion and of the lateral portions are elastic, that is to say have a large elongation capacity, with a total elongation at break At at least equal to 4%.

Preferably also, the median tensile elastic modulus is at least equal to 110 GPa. This lower limit forces the median tensile elastic modulus to be in the range [110 GPa, 150 GPa], and therefore in the high range of tensile elastic moduli, making it possible for there to be a significant difference in stiffness between the median portion and the lateral portions of the hooping layer.

According to one preferred embodiment, the elastic metal reinforcers of the median portion and of the lateral portions of the at least one circumferential hooping layer are multistrand ropes of structure 1×N comprising a single layer of N strands wound in a helix, each strand comprising an internal layer of M internal threads wound in a helix and an external layer of K external threads wound in a helix around the internal layer. The formulas of multistrand ropes are conventional assemblies for elastic ropes.

According to a preferred variant of the above preferred embodiment, the single layer of N strands, wound in a helix, comprises N=3 or N=4 strands, preferably N=4 strands.

Preferably also, the internal layer of M internal threads, wound in a helix, of each strand comprises M=3, 4 or 5 internal threads, preferably M=3 internal threads.

Likewise preferably, the external layer of K external threads, wound in a helix around the internal layer of each strand, comprises K=7, 8, 9, 10 or 11 external threads, preferably K=8 external threads.

According to a usual embodiment, the circumferential hoop reinforcement comprises at least two circumferential hooping layers, in order to obtain the desired level of circumferential stiffness and therefore of hooping.

According to a preferred variant, the respective axial widths of the at least two circumferential hooping layers are the same, for reasons of ease of manufacture.

In a first advantageous configuration, the circumferential hoop reinforcement is positioned radially between two working layers of the working reinforcement.

In a second advantageous configuration, the circumferential hoop reinforcement is positioned radially on the inside of the working reinforcement.

The radial positioning of the circumferential hoop reinforcement with respect to the working reinforcement has an impact on the distribution of loads in the crown and the associated risks of the various components of the crown reinforcement being damaged. Thus, the more the circumferential hoop reinforcement is radially on the outside, the more the tensile loads in the circumferential hoop reinforcement, and therefore the associated risk of rupture, decrease. Furthermore, the shear at the ends of the working reinforcement, and therefore the risk of cleavage, increases. In addition, keeping the circumferential hoop reinforcement at a distance from the carcass reinforcement reduces the risk of the carcass reinforcement cracking.

Advantageously, the metal reinforcers of the at least one protective layer form an angle at least equal to 15° and at most equal to 35° with the circumferential direction.

Advantageously also, the protective reinforcement comprises two protective layers, the respective metal reinforcers of which are crossed from one protective layer to the next.

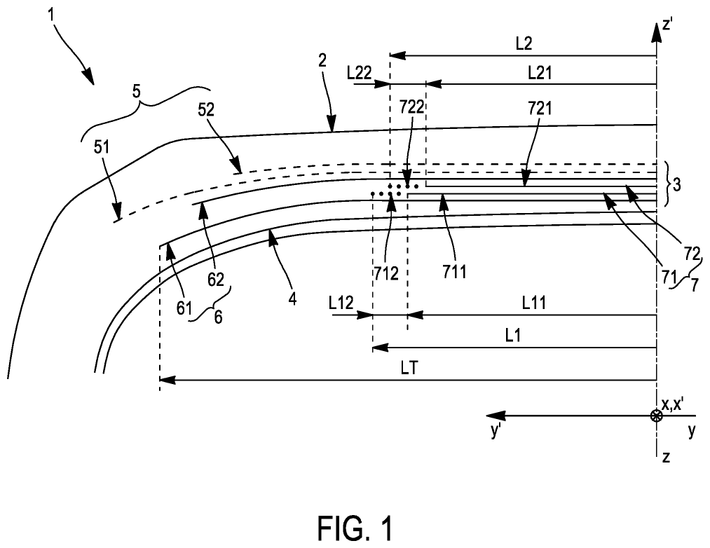

The features of the invention are illustrated by the schematic FIGS. 1, 2A, 2B and 3, which are not drawn to scale.

FIG. 1: Meridian half-section of a crown of a tire for a heavy-duty vehicle of construction plant type according to the invention.

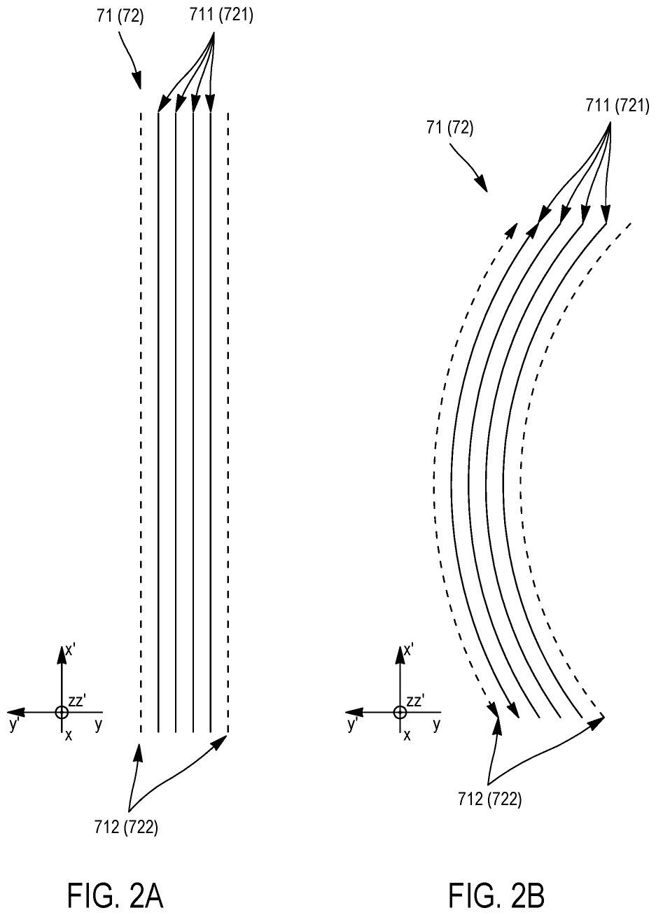

FIG. 2A: Schematic top view of a circumferential hooping layer at rest.

FIG. 2B: Schematic top view of a circumferential hooping layer under edgewise bending.

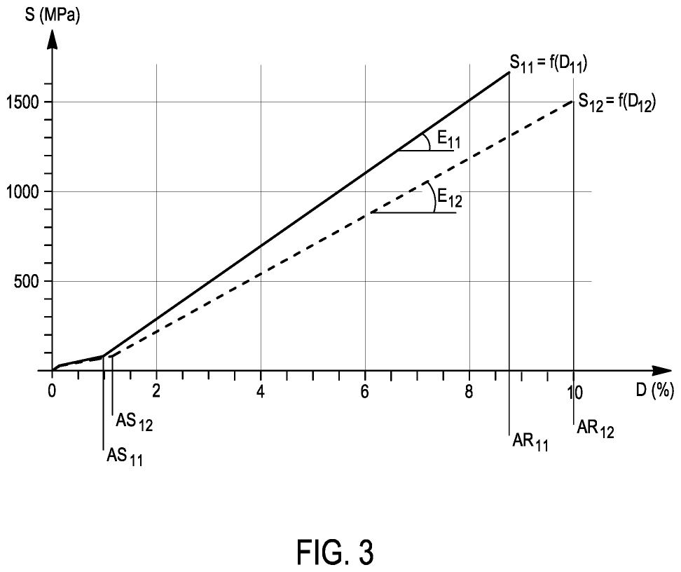

FIG. 3: Model tensile behaviour laws for a median portion and a lateral portion of a circumferential hooping layer.

FIG. 1 shows a meridian half-section, on a plane YZ, of a tire 1 for a heavy-duty vehicle of construction plant type according to the invention, comprising a crown reinforcement 3 radially on the inside of a tread 2 and radially on the outside of a carcass reinforcement 4. The crown reinforcement 3 comprises, radially from the outside to the inside, a protective reinforcement 5 and a working reinforcement 6. The protective reinforcement 5 comprises two protective layer (51, 52) comprising elastic metal reinforcers having a tensile elastic modulus at most equal to 150 GPa, which are coated in an elastomeric material, are mutually parallel, form an angle at least equal to 10° (not shown) with a circumferential direction XX′ tangential to the circumference of the tire, and are crossed from one protective layer to the next. The working reinforcement 6 comprises two working layers (61, 62) that respectively comprise inextensible metal reinforcers having a tensile elastic modulus greater than 150 GPa and at most equal to 200 GPa, which are coated in an elastomeric material, are mutually parallel, form an angle at least equal to 15° and at most equal to 45° (not shown) with the circumferential direction XX′, and are crossed from one working layer to the next. The working reinforcement 6 has an axial width LT defined as the width of the widest working layer, which, in the example shown, is the radially innermost working layer 61. The crown reinforcement 3 also comprises, radially on the inside of the protective reinforcement 5, a circumferential hoop reinforcement 7 positioned radially between the two working layers (61, 62) of the working reinforcement 6. The circumferential hoop reinforcement 7 comprises two circumferential hooping layers (71, 72) that respectively have an axial width (L1, L2) and comprise metal reinforcers which are coated in an elastomeric material, are mutually parallel and form an angle at most equal to 5° (not shown) with the circumferential direction XX′. In the example shown, the axial widths (L1, L2) of the two circumferential hooping layers (71, 72) are not the same. According to the invention, each circumferential hooping layer (71, 72) comprises a median portion (711, 721) having a median width (L11, L21) and a median tensile elastic modulus (E11, E21), and two lateral portions (712, 722) that axially extend the median portion (711, 721) on either side and each have a lateral width (L12, L22) and a lateral tensile elastic modulus (E12, E22). The lateral width (L12, L22) is at least equal to 0.05 times the median width (L11, L21) and the lateral tensile elastic modulus (E12, E22) is at most equal to 0.9 times the median tensile elastic modulus (E11, E21). Given that the invention is depicted in a meridian half-section, which is symmetric with respect to the plane XZ, only the respective halves of the widths L1, L11, L2, L21 and LT are shown and, likewise, only one lateral portion (712, 722) of each circumferential hooping layer (71, 72) is shown.

FIG. 2A shows a schematic top view of a circumferential hooping layer (71, 72) at rest. The elastic metal reinforcers of each lateral portion (712, 722) are shown using dashed lines, while those of each median portion (711, 721) are shown using solid lines. At rest, all of these metal reinforcers, which are mutually parallel, are positioned in circumferential planes XZ.

FIG. 2B shows a schematic top view of a circumferential hooping layer (71, 72) deformed under edgewise bending, when the tire is subjected to a cornering angle about a radial direction ZZ′. The elastic metal reinforcers of the lateral portion (712, 722) under tension are more flexible than those of the median portion (711, 721), since, according to the invention, the lateral tensile elastic modulus (E12, E22) is at most equal to 0.9 times the median tensile elastic modulus (E11, E21), and therefore have an elongation capacity that makes it possible to limit the tensile stress to which they are subjected.

FIG. 3 shows model tensile behaviour laws for the constituent metal reinforcers of a median portion and the constituent metal reinforcers of a lateral portion, respectively, of a circumferential hooping layer. For the median portion and each lateral portion, respectively, the tensile stress (S11, S12), expressed in MPa, defined as the ratio between the tensile load, expressed in N, and the reinforcer section, expressed in mm, is shown as a function of the tensile deformation (D11, D12), that is to say the corresponding relative elongation, expressed in %. For each of the behaviour laws shown, the tensile stress (S11, S12) varies very little up to a first value of tensile deformation corresponding to the structural elongation (AS11, AS12) of the respective elastic metal reinforcers of the median portion and lateral portion, and then increases with a gradient corresponding to the tensile elastic modulus (E11, E12) up to a tensile deformation at break (AR11, AR12). This graph shows that the lateral tensile elastic modulus E12 is at most equal to 0.9 times the median tensile elastic modulus E11.

The inventors compared two tires I1 and I2 according to the invention against a reference tire R, for the tire size 59/80 R 63.

The reference tire R and the tires I1 and I2 according to the invention all have a crown reinforcement 3 having the same radial stack of crown layers. The crown reinforcement 3 comprises, radially from the outside to the inside, a protective reinforcement 5 having two protective layers (51, 52), the respective elastic metal reinforcers of which, which are crossed from one layer to the next, form an angle equal to 33° with the circumferential direction XX′, and a working reinforcement 6 having two working layers (61, 62), the respective inextensible metal reinforcers of which, which are crossed from one layer to the next, form an angle equal to 33° with the circumferential direction XX′. The crown reinforcement 3 also comprises, radially interposed between the working layers (61, 62) of the working reinforcement 6, a circumferential hoop reinforcement 7 having two circumferential hooping layers (71, 72), the respective elastic metal reinforcers of which form an angle substantially equal to 0° with the circumferential direction.

For the reference tire R, the two circumferential hooping layers (71, 72), which have an axial width L1 equal to 520 mm and an axial width L2 equal to 520 mm, respectively, comprise elastic metal reinforcers of the multistrand rope type of structure 44.35=4*(3+8)*35, that is to say made up of N=4 strands, each strand comprising an internal layer of M=3 internal threads and an external layer of K=8 external threads wound in a helix around the internal layer, the threads having a section of diameter d=0.35 mm, in a variant referred to as V1. For the variant V1 of rope 44.35 in question, the reinforcers have a tensile elastic modulus E_{R} equal to 130 GPa, a diameter D equal to 3.8 mm, and are distributed axially at an axial spacing P equal to 4.4 mm, resulting in a tensile elastic modulus of each hooping layer equal to E_{R}*(Π*D)/(4*P)=130*(Π*3.8)/(4*4.4)=88 GPa.

For the tire I1 according to the invention, the two circumferential hooping layers (71, 72) have an axial width L1 equal to 520 mm and an axial width L2 equal to 520 mm, respectively. The two circumferential hooping layers (71, 72) each comprise a median portion (711, 721), having a median width (L11, L21) equal to 410 mm and a median tensile elastic modulus (E11, E21) equal to 88 GPa, and two lateral portions (712, 722) that axially extend the median portion (711, 721) on either side, each lateral portion (712, 722) having a lateral width (L12, L22) equal to 55 mm and a lateral tensile elastic modulus (E12, E22) equal to 79 GPa. In the present case, the lateral width (L12, L22) is equal to 410/520=0.13 times the median width (L11, L21) and therefore at least equal to 0.05 times the median width (L11, L21). The lateral tensile elastic modulus (E12, E22) is equal to 79/88=0.9 times the median tensile elastic modulus (E11, E21). The median tensile elastic modulus (E11, E21) of the median portion (711, 721) results from the use of elastic metal reinforcers of the multistrand rope type of structure 44.35=4*(3+8)*35, that is to say made up of N=4 strands, each strand comprising an internal layer of M=3 internal threads and an external layer of K=8 external threads wound in a helix around the internal layer, the threads having a section of diameter d=0.35 mm, in a variant referred to as V1. For the variant V1 of rope 44.35 in question, the reinforcers have a tensile elastic modulus E_{R} equal to 130 GPa, a diameter D equal to 3.8 mm, and are distributed axially at an axial spacing P equal to 4.4 mm, resulting in a median tensile elastic modulus (E11, E21) equal to E_{R}*(Π*D)/(4*P)=130*(Π*3.8)/(4*4.4)=88 GPa. The lateral tensile elastic modulus (E12, E22) of the lateral portion (712, 722) results from the use of elastic metal reinforcers of the multistrand rope type of structure 44.35=4*(3+8)35, that is to say made up of N=4 strands, each strand comprising an internal layer of M=3 internal threads and an external layer of K=8 external threads wound in a helix around the internal layer, the threads having a section of diameter d=0.35 mm, but in a variant referred to as V2. For the variant V2 of rope 44.35 in question, the reinforcers have a tensile elastic modulus E_{R} equal to 117 GPa, a diameter D equal to 3.8 mm, and are distributed axially at an axial spacing P equal to 4.4 mm, resulting in a lateral tensile elastic modulus (E12, E22) equal to E_{R}*(Π*D)/(4*P)=117*(Π*3.8)/(4*4.4)=79 GPa.

The tire I2 according to the invention differs from the tire I1 only by the nature of the elastic metal reinforcers of the lateral portions (712, 722) of the circumferential hooping layers (71, 72). In this case, the lateral tensile elastic modulus (E12, E22) is equal to 46 GPa, i.e. 46/88=0.52 times the median tensile elastic modulus (E11, E21) equal to 88 GPa, and therefore at most equal to 0.9 times the median tensile elastic modulus (E11, E21). The lateral tensile elastic modulus (E12, E22) of the lateral portion (712, 722) results from the use of elastic metal reinforcers of the multistrand rope type of structure 52.26=4*(5+8)*26, that is to say made up of N=4 strands, each strand comprising an internal layer of M=5 internal threads and an external layer of K=8 external threads wound in a helix around the internal layer, the threads having a section of diameter d=0.26 mm These reinforcers have a tensile elastic modulus E_{R} equal to 70 GPa, a diameter D equal to 3.1 mm, and are axially distributed at an axial spacing P equal to 3.7 mm, resulting in a lateral tensile elastic modulus (E12, E22) equal to E_{R}*(Π*D)/(4*P)=70*(Π*3.1)/(4*3.7)=46 GPa.

The respective technical features of the tires R, I1 and I2, set out above, are summarized in Table 1 below:

TABLE 1

| | | | Tire I1 according | | Tire I2 according | |
|---|---|---|---|---|---|---|
| Size 59/80R63 | Reference tire R | | to the invention | | to the invention | |
| Axial width L1 | 520 | mm | 520 | mm | 520 | mm |
| Median width L11 | N/A | | 410 | mm | 410 | mm |
| Lateral width L12 | N/A | | 55 | mm | 55 | mm |
| Axial width L2 | 520 | mm | 520 | mm | 520 | mm |

| | | | | | |
|---|---|---|---|---|---|
| Median width L21 | N/A | 410 | mm | 410 | mm |
| Lateral width L22 | N/A | 55 | mm | 55 | mm |

| Type of layer 71 (72) reinforcer | 44.35 V1 = | | N/A | N/A |
|---|---|---|---|---|
| | 4*(3 + 8)*35 | | | |
| Tensile elastic modulus E_{R} of a layer | 130 | GPa | N/A | N/A |
| 71 (72) reinforcer | | | | |
| Diameter D of a layer 71 (72) reinforcer | 3.8 | mm | N/A | N/A |
| Axial spacing P of the layer 71 (72) | 4.4 | mm | N/A | N/A |
| reinforcers | | | | |
| Tensile elastic modulus E1 (E2) of a layer | 88 | GPa | N/A | N/A |
| 71 (72) (=E_{R}*(II*D/(4*P)) | | | | |

| Type of median portion reinforcer of layer | N/A | 44.35 V1 = | | 44.35 V1 = | |
|---|---|---|---|---|---|
| 711 (721) | | 4*(3 + 8)*35 | | 4*(3 + 8)*35 | |
| Tensile elastic modulus E_{R} of a median | N/A | 130 | GPa | 130 | GPa |
| portion reinforcer of layer 711 (721) | | | | | |
| Diameter D of a median portion reinforcer of | N/A | 3.8 | mm | 3.8 | mm |
| layer 711 (721) | | | | | |
| Axial spacing P of the median portion | N/A | 4.4 | mm | 4.4 | mm |
| reinforcers of layer 711 (721) | | | | | |
| Median tensile elastic modulus E11 (E21) of | N/A | 88 | GPa | 88 | GPa |
| a median portion of layer 711 (721) | | | | | |
| (=E_{R}*(II*D/(4*P)) | | | | | |
| Type of lateral portion reinforcer of layer | N/A | 44.35 V2 = | | 52.26 = | |
| 712 (722) | | 4*(3 + 8)*35 | | 4*(5 + 8)*26 | |
| Tensile elastic modulus E_{R} of a lateral | N/A | 117 | GPa | 70 | GPa |
| portion reinforcer of layer 712 (722) | | | | | |
| Diameter D of a lateral portion reinforcer | N/A | 3.8 | mm | 3.1 | mm |
| of layer 712 (722) | | | | | |
| Axial spacing P of the lateral portion | N/A | 4.4 | mm | 3.7 | mm |
| reinforcers of layer 712 (722) | | | | | |
| Lateral tensile elastic modulus E12 (E22) | N/A | 79 | GPa | 46 | GPa |
| of a lateral portion reinforcer of layer | | | | | |
| 712 (722) (=E_{R}*(II*D/(4*P)) | | | | | |

The inventors carried out, for the tires R, I1 and I2, running finite-element numerical simulations, the tire being inflated to a pressure P equal to 7 bar, compressed under a radial load Z equal to 102 024 daN (104 tonnes), and subjected to a lateral drift thrust Fy equal to 25% of the radial load Z. They thus determined the maximum tensile loads in the circumferential hooping layers and/or in the respective median and lateral portions thereof, presented in Table 2 below.

TABLE 2

| | | Tire I1 according to | Tire I2 according to |
|---|---|---|---|
| | | the invention: - | the invention: - |
| | | median portion | median portion |
| | Reference | reinforcers of type | reinforcers of type |
| | tire R: - | 44.35 V1 - lateral | 44.35 V1 - lateral |
| | reinforcers | portion reinforcers | portion reinforcers |
| | of type | of type | of type |
| | 44.35 V1 | 44.35 V2 | 52.26 |
| Tensile load T max in the layer 71 | 418 daN | | |
| reinforcers (daN) | | | |
| Tensile load T max in the layer 72 | 348 daN | | |
| reinforcers (daN) | | | |
| Tensile load T max in the median | | 296 daN | 293 daN |
| portion 711 reinforcers of layer 71 | | | |
| (daN) | | | |
| Tensile load T max in the lateral | | 331 daN | 263 daN |
| portion 712 reinforcers of layer 71 | | | |
| (daN) | | | |
| Tensile load T max in the median | | 230 daN | 228 daN |
| portion 721 reinforcers of layer 72 | | | |
| (daN) | | | |
| Tensile load T max in the lateral | | 276 daN | 228 daN |
| portion 722 reinforcers of layer 72 | | | |
| (daN) | | | |

Table 2 shows, compared with the reference tire R:
For the tire I1: a reduction in the maximum tensile loads equal to (331−418)*100/418=−21% for the reinforcers of the lateral portion 712 of the radially inner layer 71, and equal to (276−348)*100/348=−21% for the reinforcers of the lateral portion 722 of the radially outer layer 72.
For the tire I2: a reduction in the maximum tensile loads equal to (263−418)*100/418=−37% for the reinforcers of the lateral portion 712 of the radially inner layer 71, and equal to (228-348)*100/348=−35% for the reinforcers of the lateral portion 722 of the radially outer layer 72.

This significant reduction in the maximum tensile loads in the lateral portion reinforcers of the circumferential hooping layer causes a significant increase in the rupture strength of the hoop reinforcement, at the axial ends thereof.

The inventors furthermore determined the maximum amplitudes of shear deformations, as the wheel turns, in the elastomeric compounds, positioned radially on the inside and on the outside of the axial end portions of the radially outermost working layer 72, this criterion being considered relevant as regards the endurance of the crown with regard to cleavage. These maximum amplitudes of shear deformations are presented in Table 3 below:

TABLE 3

| | | Tire I1 according | Tire I2 according |
|---|---|---|---|
| | | to the invention: - | to the invention: - |
| | | median portion | median portion |
| | Reference | reinforcers of type | reinforcers of type |
| | tire R: - | 44.35 V1 - lateral | 44.35 V1 - lateral |
| | reinforcers | portion reinforcers | portion reinforcers |
| | of type | of type | of type |
| | 44.35 V1 | 44.35 V2 | 52.26 |
| Maximum amplitude of shear elongation | 0.80 rad | 0.81 rad | 0.81 rad |
| radially on the outside of the working | | | |
| layer 72 | | | |
| Maximum amplitude of shear elongation | 0.62 rad | 0.63 rad | 0.63 rad |
| radially on the inside of the working | | | |
| layer 72 | | | |

According to Table 3, the maximum amplitudes of shear elongation remain substantially at the same level between the tires R, I1 and I2, resulting in performance aspects in terms of endurance with regard to cleavage of the crown that are substantially identical between the reference tire and the tires according to the invention.

1. A tire for a heavy-duty vehicle of construction plant type, comprising a crown reinforcement radially on the inside of a tread and radially on the outside of a carcass reinforcement,
the crown reinforcement comprising, radially from the outside to the inside, a protective reinforcement and a working reinforcement,
the protective reinforcement comprising at least one protective layer comprising elastic metal reinforcers having a tensile elastic modulus at most equal to 150 GPa, which are coated in an elastomeric material, are mutually parallel and form an angle at least equal to 10° with a circumferential direction (XX′) tangential to the circumference of the tire,
the working reinforcement comprising two working layers that respectively comprise inextensible metal reinforcers having a tensile elastic modulus greater than 150 GPa and at most equal to 200 GPa, which are coated in an elastomeric material, are mutually parallel, form an angle at least equal to 15° and at most equal to 45° with the circumferential direction (XX′), and are crossed from one working layer to the next,
the crown reinforcement also comprising, radially on the inside of the protective reinforcement, a circumferential hoop reinforcement,
the circumferential hoop reinforcement comprising at least one circumferential hooping layer having an axial width (L1, L2) and comprising metal reinforcers which are coated in an elastomeric material, are mutually parallel and form an angle at most equal to 5° with the circumferential direction (XX′), wherein the at least one circumferential hooping layer comprises a median portion having a median width (L11, L21) and a median tensile elastic modulus (E11, E12), and two lateral portions that axially extend the median portion on either side and each have a lateral width (L12, L22) and a lateral tensile elastic modulus (E12, E22), in that the lateral width (L12, L22) is at least equal to 0.05 times the median width (L11, L21), and in that the lateral tensile elastic modulus (E12, E22) is at most equal to 0.9 times the median tensile elastic modulus (E11, E21).

2. The tire according to claim 1, wherein the lateral width (L12, L22) is at most equal to 0.5 times the median width (L11, L21).

3. The tire according to claim 1, wherein the lateral tensile elastic modulus (E12, E22) is at least equal to 0.3 times the median tensile elastic modulus (E11, E21).

4. The tire according to claim 1, wherein the working reinforcement has an axial width (LT), and wherein the axial width (L1, L2) of the at least one circumferential hooping layer is at least equal to 0.3 times and at most equal to 0.7 times the axial width (LT) of the working reinforcement.

5. The tire according to claim 1, wherein the median portion and the lateral portions of the at least one circumferential hooping layer respectively comprise elastic metal reinforcers having a tensile elastic modulus at most equal to 150 GPa.

6. The tire according to claim 5, wherein the median tensile elastic modulus (E11, E21) is at least equal to 110 GPa.

7. The tire according to claim 5, wherein the elastic metal reinforcers of the median portion and of the lateral portions of the at least one circumferential hooping layer are multistrand ropes of structure 1×N comprising a single layer of N strands wound in a helix, each strand comprising an internal layer of M internal threads wound in a helix and an external layer of K external threads wound in a helix around the internal layer.

8. The tire according to claim 7, wherein the single layer of N strands, wound in a helix, comprises N=3 or N=4 strands, preferably N=4 strands.

9. The tire according to claim 7, wherein the internal layer of M internal threads, wound in a helix, of each strand comprises M=3, 4, or 5 internal threads, preferably M=3 threads.

10. The tire according to claim 7, wherein the external layer of K external threads, wound in a helix around the internal layer of each strand, comprises K=7, 8, 9, 10 or 11 external threads, preferably K=8 external threads.

11. The tire according to claim 1, wherein the circumferential hoop reinforcement comprises at least two circumferential hooping layers.

12. The tire according to claim 11, wherein the respective axial widths (L1, L2) of the at least two circumferential hooping layers are the same.

13. The tire according to claim 1, wherein the circumferential hoop reinforcement is positioned radially between two working layers of the working reinforcement.

14. The tire according to claim 1, wherein the circumferential hoop reinforcement is positioned radially on the inside of the working reinforcement.
